(19) United States
(12) Patent Application Publication
(10) Pub. No.: US 2026/0352856 A1
(43) Pub. Date: Nov. 5, 2026

(54) Method and device for encoding and decoding images

(71) Applicant: ORANGE, Issy-les-Moulineaux (FR)

(72) Inventors: Pierrick PHILIPPE, CHATILLON (FR); Félix HENRY, CHATILLON (FR); Theo LADUNE, CHATILLON (FR); Gordon CLARE, CHATILLON (FR)

(21) Appl. No.: 19/487,123

(22) PCT Filed: May 7, 2024
(86) PCT No.: PCT/EP2024/062654

§ 371 Date: Nov. 24, 2025

(30) Foreign Application Priority Data
May 24, 2023 (FR) FR2305153

(51) Int. Cl. H04N 19/42; H04N 19/132; H04N 19/136; H04N 19/167; H04N 19/463

(52) U.S. Cl. CPC H04N 19/42; H04N 19/132; H04N 19/136; H04N 19/167; H04N 19/463

(57) ABSTRACT

A method and device for encoding and decoding images includes a plurality of samples to be encoded or decoded. The decoding method includes: decoding a group of feature maps; obtaining a set of synthesis parameters representative of a synthesis module; obtaining a set of convolution parameters representative of a convolutional neural network; processing the group of feature maps by way of the synthetic neural network to provide a group of latent value maps, the number of latent value maps being less than or equal to the number of feature maps; and processing the group of latent value maps by way of the convolutional neural network to provide the at least one decoded image.

### PRIOR ART

The invention relates to the general field of encoding sequences of digital images.

Digital images or videos are generally source encoded with the aim of compressing them in order to limit the resources required for their transmission and/or storage. There are many encoding standards, such as the standards of the ITU/MPEG organizations (H.264/AVC, H.265/HEVC, H.266/VVC, etc.) and their extensions (MVC, SVC, 3D-HEVC, etc.).

Video formats are continuously evolving for even greater compression and to match the variety of expected formats and communication networks, prediction possibilities are becoming ever greater and conventional encoding and decoding algorithms are becoming very complex.

In addition to these conventional approaches proposed by the compression standards (MPEG, ITU), approaches based on artificial intelligence, and in particular neural approaches, are tending to develop.

Some of these neural approaches can be considered to be a simple extension of the notion of competition among the aforementioned compression techniques, such as prediction and video encoding transformation method competition.

Other approaches use the “autoencoder” concept. Autoencoders are artificial-neural-network-based learning algorithms that allow a new representation of a dataset to be constructed. The architecture of an autoencoder is made up of two parts: the encoder and the decoder. The encoder is formed by a set of layers of neurons, which process the data in order to construct new representations, referred to as “encoded” representations, also called “latent representations”. In turn, the layers of neurons of the decoder receive these representations and filter them in order to attempt to reconstruct the original data. The differences between the reconstructed data and the initial data allow any errors made by the autoencoder to be measured. Training involves changing the parameters of the autoencoder in order to reduce the reconstruction error measured on the various samples of the dataset. The performance capabilities of such autoencoder-based systems are achieved at the expense of a considerable increase in memory footprint and in complexity compared with conventional approaches such as those proposed by the compression standards. They can have millions of parameters and can require around one million MAC (multiply-accumulate) operations to decode a single pixel. This makes such decoders much more complex than conventional decoders, which could hinder the adoption of learning-based compression. Moreover, the neural networks used for the encoder and the decoder are different. The document US 2022/0385907 describes such an auto-encoder system.

More recently, a simple neural-network-based image encoding technique has been described in the article entitled, “Compression with Implicit Neural representations” by Emilien Dupont et al. (arXiv:2103.03123). The proposed encoding technique involves adjusting a neural network for an image, quantizing the weights of the network and transmitting them. At the time of decoding, the neural network is evaluated in each pixel position in order to reconstruct the image. Such a technique nevertheless remains inefficient in terms of compression.

The document US 2022/0385907 also describes an encoding and decoding system based on the use of implicit neuronal representations of this kind.

There is, however, a need for a solution for encoding/compressing a sequence of images simply and efficiently.

### DISCLOSURE OF THE INVENTION

The subject of the invention is a method for encoding at least one image, comprising the following steps:
a step of constructing said at least one encoded and then decoded image, comprising the substeps of:
   constructing a group of feature maps;
   processing said group of feature maps by way of a synthesis module, defined by synthesis parameters, to provide a group of latent value maps, the number of latent value maps being less than or equal to the number of feature maps;
   processing said group of latent value maps by way of at least one convolutional neural network, defined by convolution parameters, to provide said at least one encoded and then decoded image;
   updating at least one value of one of said feature maps and/or at least one synthesis parameter and/or at least one convolution parameter, according to an encoding performance measurement;
a step of encoding said group of feature maps and said set of synthesis and convolution parameters.

The subject of the invention is also a method for decoding at least one image from a bit stream, comprising the following steps:
decoding a group of feature maps;
obtaining a set of synthesis parameters representative of a synthesis module;
obtaining a set of convolution parameters representative of at least one convolutional neural network;
processing said group of feature maps by way of said synthesis module to provide a group of latent value maps, the number of latent value maps being less than or equal to the number of feature maps;
processing said group of latent value maps by way of said at least one convolutional neural network to provide said at least one decoded image.

Within the meaning of the invention, the term “encoding” or “coding” is understood to mean the operation involving representing a set of samples, or pixels, of the image or plurality of images in a compact form conveyed, for example, by a digital bit stream. The term “decoding” is understood to mean the operation involving processing a digital bit stream to render decoded samples of the image or plurality of images.

The term “image” is understood to mean a two-dimensional digital image containing one or more (color, depth, view, etc.) components.

The term “at least one image” is understood to mean a plurality of ordered two-dimensional images, for example in chronological order in the case of a video. According to another example, the images can be views of the same scene displayed as multiple views. According to another example, the images can be a plurality of temporal and multiple view images (immersive video).

The term “sample” or “pixel” is understood to mean a value or a set of values taken from an image. Sampling a signal produces a sequence of discrete values known as samples. In the case of an image signal, the sample is referred to as a pixel, which can be, for example, a color pixel traditionally represented by a triplet of values, each value belonging to one component, for example (R, G, B) or (Y, U, V). The position of the sample can be identified by its coordinates on the abscissa (x) and on the ordinate (y) in the image.

The term “feature map” is understood to mean part of an abstract representation of an image or a sequence of images, containing a plurality of variable scalar data, also called characteristic values, for example real numbers, or integers, signed or unsigned. The abstract representation of an image or sequence can therefore contain multiple feature maps. The abstract representation of one or more images may also correspond to a single feature map.

The term “latent value map” is understood to mean part of an abstract representation of an image or a sequence of images, containing a plurality of variable scalar data, also called latent values, for example real numbers, or integers, signed or unsigned. The abstract representation of an image or sequence can therefore contain multiple latent value maps. The abstract representation of one or more images may also correspond to a single latent value map. These maps result from processing the feature maps by way of a synthesis module, for example a synthetic neural network.

The term “synthesis module” is understood to mean, for example, a neural network, or a filter bank, or a linear inverse transformation (wavelet, DCT, etc.), defined by its parameters Wₖ that is able to process the transformed feature maps at the input to output a set of NL latent value maps.

The terms “synthetic neural network” and “convolutional neural network” are understood to mean a neural network such as a convolutional neural network, a multilayer perceptron, etc. The neural network is defined, for example, by a plurality of layers of artificial neurons and by a set of activation, weighting and addition functions (for example, one layer can compute y=f(Ax+b), where y and b are vectors of dimension N, x is a vector of dimension M, A is a matrix of dimension M×N, and f is the activation function).

The term “parameter of the neural network” is understood to mean one of the values that characterizes the neural network, or the plurality of neural networks, for example a weight associated with one of the neurons (filter coefficient, values of a matrix, weighting, bias, value affecting the operation of the non-linearity, etc.).

The term “generation of said at least one image” is understood to mean a step that is intended to reconstruct the decoded samples of the image or of the plurality of images.

The term “performance measurement” is understood to mean a measurement between at least one value of a sample to be encoded and a decoded value of said sample. The measurement can evaluate, for example, a distortion, or a perceptual error. It can be performed on one sample or a plurality of samples (for example the current samples, or the current images, etc.). The measurement can also comprise a measurement of the rate, in particular the rate associated with encoding the neural network and/or encoding the feature maps of the group. The measurement can be a joint measurement of the rate and the distortion achieved by weighting them. As is well known in the prior art, the value of this measurement is generally minimized until a target value is reached.

The term “construction step” means a step that is intended to construct the encoded and then decoded values of the pixels of the image or of the plurality of images, and the parameters representative of the image, in particular the values of the feature maps and the parameters of the neural networks, prior to their effective encoding. The construction substeps can be reiterated as many times as necessary in order to obtain an acceptable performance measurement.

Generally, it is assumed that the steps of an encoding or decoding method should not be interpreted as being associated with a notion of temporal succession. In other words, the steps can be performed in an order different from that indicated in the independent encoding or decoding claim, or even at the same time.

The encoding method according to the invention constructs the encoding parameters from an input image or sequence of images by training neural networks on feature maps and then latent value maps, which can be at the resolution of the input images or at a lower resolution. During training, or construction, the parameters of the neural network and the values of the feature maps and latent value maps are updated according to a performance measurement, for example of the rate/distortion type. When training has ended, that is to say the performance measurement obtained is satisfactory, the actual encoding of the parameters of the neural networks and the values of the feature maps can be performed and stored or transmitted to the decoder. Latent value maps are neither encoded nor transmitted.

Advantageously, the training process allows the parameters of the neural network and/or the values of the feature maps to be refined until a representation is obtained that is adequate in terms of performance, for example a desired balance between the generated rate and the distortion undergone by the input image or sequence of images being encoded. The training of the values of the feature maps and of the parameters of the neural networks can be carried out jointly. Advantageously, the encoding method according to the invention allows the signal to be efficiently compressed.

Advantageously, the compression of the feature maps is efficient since it makes it possible to convey it over networks or on storage media with reduced capacities.

Moreover, the use of two sets of networks, synthetic and then convolution, is advantageous in itself, because it allows the two networks to be trained separately to ensure better convergence. According to some embodiments, it is possible to freeze one of the two networks and learn only one, so only the parameters of the learned network will be transmitted to the decoder.

Moreover, since the number of latent value maps is less than or equal to the number of feature maps, the number of operations to be performed by the convolutional network is limited. This results in reduced complexity because less data are processed. Advantageously, the decoding method is simple since it suffices to decode the feature maps associated with an image or with a group of images, and to obtain the synthetic and/or convolutional neural networks, in order to recover a decoded version of the current image or of the group of current images.

Such a synthetic or convolutional neural network can advantageously have a very simple structure with few parameters and few operations per sample.

According to embodiments of the encoding or decoding method:
said at least one image comprises a plurality of samples to be decoded, and the step of processing said group of feature maps to provide a group of latent value maps comprises the following substeps:
for at least one sample, referred to as the current sample, of said at least one image to be decoded, which sample is associated with a position:
   constructing a characteristic vector from the feature maps according to said position of said current sample, and:
   processing said characteristic vector by way of said synthesis module to provide a latent vector that is representative of a latent value of the current sample;
constructing the group of latent value maps from said at least one latent vector.

Advantageously, according to this embodiment, the synthesis module is of the positional type; the linking of a synthetic network of the positional type and a convolutional network making it possible to carry out local processing in the synthetic network and then to correct it using the convolutional network.
The synthesis module comprises a multilayer perceptron, or MLP. Such a neural network can advantageously have a very simple structure with few parameters. Moreover, decoding can be performed sample by sample, progressively and on a particular block of the image.
The convolutional network contains at least one convolutional layer. Thus, non-localized processing of the image can be performed, which improves the consistency of the generated image by limiting noise and improving the contours present in the image.
The number of latent value maps is equal to the number of components of the image. Advantageously, the complexity is limited by processing exactly the number of components of the output pixels (for example three in the case of an RGB or YUV image). According to a variant, each of the latent value maps (for example corresponding to the Y, U and V components) can be processed independently. This further limits the complexity of the processing, since there are fewer multiplication/addition operations for the convolutional network, and consequently the space required in the memory of the encoder and the decoder is limited, and the cost of the convolution parameters is lower.
At least part of the set of synthesis and/or convolution parameters is obtained (or encoded) from data of said bit stream (or encoded in the bit stream); advantageously according to this embodiment, the parameters of the neural networks are transmitted in the stream. The synthesis and/or convolution module can be transmitted in a quantized form and encoded in a compact form using any quantizer and entropy encoder accessible to those skilled in the art. A format similar to that of the MPEG-7 NNR standard can be used.
At least part of the set of synthesis and/or convolution parameters is obtained (or encoded) from predetermined parameters. Advantageously, according to this embodiment, the parameters of the neural networks are accessible from the decoder, for example they can be stored in a storage memory (or encoded in a storage memory). In particular, part of the synthesis and/or convolution module can be stored in a quantized form and encoded in a compact form using any quantizer and entropy encoder accessible to those skilled in the art. A format similar to that of the MPEG-7 NNR standard can be used.
At least part of the set of synthesis and/or convolution parameters is obtained (or encoded) according to reference parameters. Advantageously, according to this embodiment, the parameters of the neural network are decoded by taking into account reference parameters that can be stored in a memory (storage memory, network, etc.) accessible from the decoder. Thus, the storage space or the transmission rate on the network can be efficiently reduced: some parameters can be encoded/decoded in a complementary manner, others cannot be encoded/decoded at all, since they are available in the reference parameters. According to variant embodiments, which can be combined with one another:
   the reference parameters can form a set of variants of a synthetic and/or convolutional network: type of convolution, attention modules, etc. Thus, only these parameters need to be encoded, inserted into the stream and decoded by the decoder;
   certain synthesis and/or convolution parameters are encoded in a manner complementary to the parameters of the reference network. Thus, it will suffice for the decoder to decode these residual parameters and then add or multiply them (or combine them in any other known manner) to/by those of the reference neural network;
   a portion of the parameters of the reference network is reused for the synthetic and/or convolutional network. For example, a complete layer of the network can be copied from the reference network, and the parameters of this layer are therefore neither encoded nor transmitted nor decoded;
   reference network indicator is transmitted in the stream. It is thus possible to indicate one network to be used for decoding among a plurality of possible networks known to the decoder.
Said at least one convolutional network contains at least two convolutional networks. Advantageously, the use of multiple cascaded networks makes it possible in particular to enhance the filtering and improve the consistency of the generated image by limiting its noise and improving its contours. In addition, each network can be learned individually or frozen independently. According to variant embodiments, which can be combined with one another:
   the bit stream contains an indicator indicating the use of at least one of said networks. Thus, depending on the required quality and complexity, one or more networks can be used for decoding. The indicator indicates, for example, that network 1 is mandatory, but that networks 2 and 3, which are cascaded behind network 1, are optional. The decoder can then choose whether or not to use them: if it uses them, it will obtain a better quality at the expense of complexity, and vice versa.
   At least two of the convolutional networks have common parameters. It is thus advantageously possible to transmit the characteristic parameters of one network, which can be used for the others, thus making it possible to reduce transmission cost. The same network is thus shared.
   At least two of the networks have an identical structure and only their weights differ in part or in whole. The same computation elements are thus shared.

At least one image has at least two dimensions, and said convolutional layer uses a kernel that is separable in said at least two dimensions. Advantageously in this embodiment, transmission cost and complexity are reduced by using separable operations (for example convolution, up-sampling, etc.), which require fewer operations than non-separable operations.

Correlatively, the subject of the invention is also an encoding device and a decoding device.

The features and advantages of the encoding or decoding method apply equally to the encoding or decoding device according to the invention, and vice versa.

The subject of the invention is also a computer program on a storage medium, this program being able to be executed in a computer or a control device according to the invention. This program contains instructions suitable for carrying out the corresponding method. This program can use any programming language and take the form of source code, object code or intermediate code between source code and object code, such as code in a partially compiled form or in any other desirable form.

The subject of the invention is also a computer-readable information medium or storage medium containing instructions for the aforementioned computer program. The information or storage media can be any entity or device capable of storing the programs. For example, the media can include a storage means, such as a ROM, for example a CD-ROM or a microelectronic circuit ROM, or even a magnetic storage means, for example a floppy disk or a hard disk, a DNA sequence, or a flash memory. Moreover, the information or storage media can be transmissible media such as an electrical or optical signal, which can be routed via an electrical or optical cable, by radio link, by wireless optical link or by other means.

A program according to the invention can in particular be downloaded from a network such as the Internet.

Alternatively, each information or storage medium can be an integrated circuit incorporating the program, the circuit being suited to carrying out or being used to carry out a method according to the invention.

### BRIEF DESCRIPTION OF THE DRAWINGS

Other features and advantages of the present invention will become apparent from the description given below with reference to the appended drawings, which illustrate exemplary embodiments thereof that are in no way limiting.

FIG. 1 schematically shows an encoding device used within the scope of the invention;

FIG. 2 schematically shows a decoding device used within the scope of the invention;

FIG. 3 schematically shows synthetic and convolutional artificial neural networks used in one embodiment of the invention during encoding and decoding;

FIG. 4 schematically shows synthetic and convolutional artificial neural networks used in another embodiment of the invention during encoding and decoding;

FIG. 5 schematically shows convolutional networks according to embodiments of the invention;

FIG. 6 schematically shows convolutional networks according to embodiments of the invention;

FIG. 7 is a flowchart showing an example of an encoding method that can be carried out by the encoding device of FIG. 1;

FIG. 8 is a flowchart showing an example of a decoding method that can be carried out by the decoding device of FIG. 2;

FIG. 9 shows an illustration of a decoding method used in one embodiment of the invention.

### DESCRIPTION OF THE EMBODIMENTS

FIG. 1 schematically shows a digital image encoding device ENC.

The input of the encoding device ENC of FIG. 1 receives a succession of samples to be encoded, which are denoted Pₙ, for example a set of image data, which is denoted I(Pₙ). The image signal I(Pₙ) can represent a two-dimensional image, or a plurality of two-dimensional images (video, color components, stereoscopic components, multiscopic components, etc.). Pₙ denotes one sample n of the input signal, which contains N samples. In one embodiment, the signal is a color-image signal represented by means of at least one two-dimensional representation, such as a matrix of pixels, of width W and height H (with N=W×H), each pixel having one red component (R), one green component (G) and one blue component (B), or, as a variant, one luma component (Y) and at least one chroma component (U and/or V) of width W_{u/v} and height H_{u/v}. The location of each pixel is defined by its x-axis and y-axis coordinates (x and y) in the image. In one embodiment, the image is grayscale and is represented by means of a two-dimensional representation, such as a pixel matrix, each pixel having a grayscale, or luma, component. In general, the number of components is denoted NC.

This encoding device ENC comprises a feature map generation module INIT, a data processing and extraction module XTR, a synthesis module MLP, a convolution module MPP corresponding to at least one convolutional artificial neural network, a feature map coding module FMC, a neural network coding module NNC, a performance function evaluation module EVAL and an update module MAJ.

The synthesis module used for encoding MLP and the synthesis module used for decoding MLP′ are defined by an identical structure, for example comprising a set of filter banks or at least one artificial neural network and a set of weights and activation functions respectively associated with the artificial neurons of the network in question.

The (at least one) convolutional artificial neural network used for encoding MPP and the convolutional artificial neural network used for decoding MPP′ are defined by an identical structure, for example comprising a plurality of layers of artificial neurons, and by a set of weights and activation functions respectively associated with the artificial neurons of the network in question.

During the encoding training, or construction, process, that is to say while the step of evaluating performance remains unsatisfactory, the coding modules (FMC and NNC) simulate encoding, followed by decoding, the results of which are sent to the evaluation module. Subsequently, they perform the actual encoding of the values of the M feature maps FMᵢ, with 1<i<=M, and of the parameters of the neural networks MLP and MPP, denoted Wₖ and Vₖ. In a known manner, the encoding simulation may be identical to the actual encoding, or may approximate it.

Each feature map contains scalar data, according to the definition of a feature map given previously, and there are M feature maps. However, it is possible to organize the characteristic values differently, for example by forming a single signal containing, for each sample, a vector of M scalar values, without loss of generality. Even if the data are organized differently, the remainder of the document assumes that there are M feature maps. The maps encoded by the module FMC for a signal, for example a current image (or plurality of images), are denoted FMCᵢ. The coding module FMC quantizes, if necessary, the values of the feature maps by using a quantizer to generate an ordered collection of quantized values. Next, the coding module compresses the quantized data, for example using an entropy encoder.

The module XTR processes and extracts the data of the feature maps. The module XTR can quantize the values of the feature maps by using a quantizer Q to generate an ordered collection of quantized values. The module XTR can alternatively obtain the data quantized by the module FMC. It should be noted that the quantization of a value refers to matching this value with a member of a discrete set of possible code symbols. For example, the set of possible code symbols can be formed by integer values, and the quantization system simply rounds a real value to an integer value. According to another example, quantization involves multiplication by a given value and then rounding. Next, according to the embodiments, the module XTR can transform the values of at least one of the feature maps, for example can perform up-sampling, interpolation, filtering, etc. In one embodiment, at the end of the transformation, a transformed feature map has the same resolution as the input signal. The module XTR then extracts data from the feature maps thus quantized and optionally transformed, which are denoted FMtᵢ, to present the data to the module MLP.

The module MLP is a synthesis module, for example a neural network, or a filter bank, or a linear inverse transformation (wavelet, DCT, etc.), defined by its parameters Wₖ that is able to process the transformed feature maps at the input to output a set of NL latent maps Lⱼ with 1<j<=NL.

According to one embodiment:
The module XTR extracts values from the transformed feature maps FMtᵢ, for a sample Pₙ to be encoded, according to its coordinates in the input signal. The extracted values form the vector Zₙ. Zₙ is a J-tuple, that is to say it contains J elements, or data zᵢ. The vector Zₙ of index n refers to the characteristic vector of the pixel Pₙ.
The module MLP comprises a neural network defined by K parameters Wₖ, with 1<k<=K, that is able to process the vector Zₙ, or J-tuple, at the input to output a second vector containing latent values representative of the sample Pₙ to be encoded. According to one embodiment, the synthetic neural network comprises an MLP, or multi-layer perceptron, formed by an input layer suitable for the input format (the J-tuple), optionally one or more hidden layers, and an output layer suitable for the output format of the output vector, generally a vector containing NL elements, each element being intended for a latent value map. According to one embodiment, NL is equal to 3 and the output vector is a triplet to be inserted into the three latent value maps L₁, L₂ and L₃ (for example Y, U and V) at the coordinates of the pixel. According to another embodiment, NL is equal to 4 and the output vector is a quadruplet to be inserted into four latent value maps L₁-L₄ at the coordinates of the pixel. According to another embodiment, NL lies between the number M of maps FMᵢ and the number of components of the image, M≤NL≤3 for three components.

According to one embodiment, the NL latent value maps contain any real values.

The latent value maps represent an intermediate signal before convolutional processing.

The (at least one) neural network MPP is of the convolutional type, that is to say it contains at least one convolutional layer. It can include convolution elements, comprising a residual or non-residual structure and/or attention modules, as will be described below.

The parameters Wₖ of the synthesis module that are encoded by the module NNC are denoted Wcₖ.

The parameters Vₖ of the convolutional neural network(s) that are encoded by the module NNC are denoted Vcₖ.

The network MPP is applied at the output of MLP to the latent value maps (Lⱼ) to obtain decoded samples P′ₙ. When all the samples Pₙ of the signal have been encoded and then decoded, a reconstructed signal I(P′ₙ) is available, that is to say at least one image I containing N decoded samples.

The module EVAL evaluates and minimizes an encoding performance. The evaluation function is of the rate/distortion type, for example. It aims to minimize the differences between the representation, at the input, of the current image I(Pₙ) and its representation I(P′ₙ) at the output, while optimizing the quantity of data to be encoded, namely the encoded feature maps, the parameters of the synthesis module Wcₖ, and the parameters of the convolutional neural network(s) Vcₖ. The minimization can be performed by way of a gradient descent, or any other method within the ability of a person skilled in the art.

The module MAJ updates the values of the maps FMᵢ to be encoded for the current image, according to the results of the performance function.

Once training of the encoder has ended, the parameters of the neural networks are encoded either losslessly, in which case the neural network MLP′/MPP′ of the decoder is identical to MLP/MPP, or lossily, in which case the network MLP′/MPP can be slightly different from MLP/MPP. The values of the feature maps, FMᵢ, are also encoded in the form of encoded data FMcᵢ, for example via an entropy encoder.

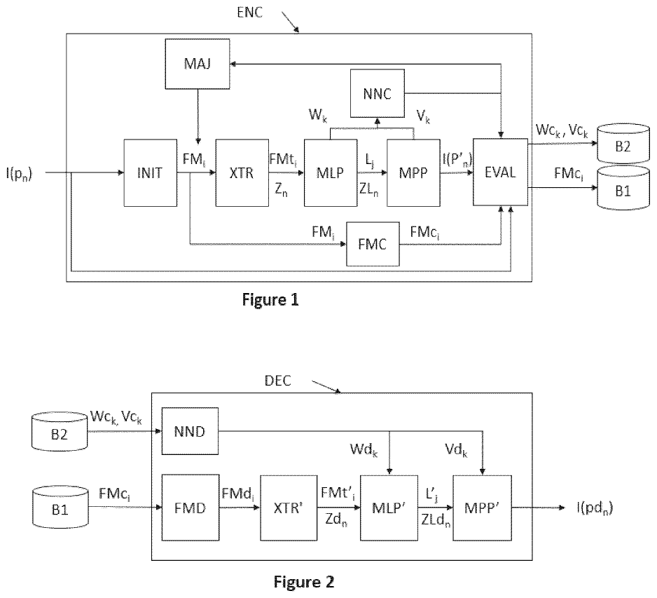

FIG. 2 schematically shows a decoding device DEC.

The decoding device DEC of FIG. 2 receives at the input a first group of encoded data organized into M feature maps FMcᵢ, the parameters Wcₖ of a synthesis module and the parameters Vcₖ of at least one convolutional neural network.

This decoding device DEC comprises a neural network decoding module NND, a feature map decoding module FMD, an inverse transformation and data extraction module XTR′, a synthesis module MLP′ and a convolution module MPP′ corresponding to at least one convolutional neural network.

The maps decoded by the module FMD, M in number, are denoted FMdᵢ.

The parameters decoded by the module NND are denoted Wdₖ and Vdₖ. If the synthesis module does not contain a neural network, a different decoder can be used to decode the parameters Wdₖ. The parameters Vdₖ and Wdₖ are identical to the parameters Vₖ and Wₖ of the encoder if the encoding has been performed losslessly.

The module XTR′ processes and extracts the data of the decoded feature maps FMdᵢ. The module XTR′ optionally performs inverse quantization corresponding to the quantization performed on the encoder. The inverse quantization is not necessary if the quantizer Q of the encoder simply rounded the real values transmitted to it. The inverse quantization is not necessary either if the neural network is able to take into account quantization of its input data. Otherwise, the decoder performs the inverse operation of the quantizer Q. Next, according to the embodiments, the module XTR′ can transform the values of at least one of the feature maps, for example can perform up-sampling, interpolation, filtering, etc. In one embodiment, at the end of the transformation, a transformed feature map has the same resolution as the input signal. The module XTR′ then extracts data from the feature maps thus quantized and optionally transformed, which are denoted FMt′ᵢ, to present the data to the module MLP.

As described above with reference to FIG. 1, the module MLP′ is a synthesis module, for example a neural network or a linear inverse transformation (wavelet, DCT, . . . ), defined by its parameters Wdₖ that is able to process the transformed feature maps at the input to output a set of NL latent maps L′ⱼ with 1<j<NL.

In one preferred embodiment:
The module XTR′ is identical to the module XTR of FIG. 1. It extracts values from the M transformed feature maps FMt′ᵢ to construct the vector Zdₙ, which takes the form of a J-tuple for a sample Pₙ to be decoded, according to its coordinates in the signal to be decoded. In one embodiment, J=M.
The module MLP′ comprises a neural network defined by K parameters Wdₖ that is able to process the vector Zdₙ, or J-tuple, at the input, that was extracted from the feature maps, to output a second vector Zldₙ of latent values representative of the sample Pₙ to be decoded. According to one embodiment, the synthetic neural network comprises an MLP, or multi-layer perceptron, formed by an input layer suitable for the input format (the J-tuple), optionally one or more hidden layers, and an output layer suitable for the output format of the output vector, generally a vector containing NL elements, each element being intended for a latent value map. According to one embodiment, NL is equal to 3 and the output vector is a triplet to be inserted into the three latent value maps L′₁, L′₂ and L′₃ at the coordinates of the pixel. According to another embodiment, R is equal to 4 and the output vector is a quadruplet to be inserted into four latent value maps L′₁-L′₄ at the coordinates of the pixel. According to another embodiment, R lies between the number M of maps FMdᵢ and the number of components of the image (s) to be decoded, M≤R≤3 for three components.

The latent value maps represent an intermediate signal before convolutional processing.

The (at least one) neural network MPP′ is of the convolutional type, that is to say it contains at least one convolutional layer. It can include convolution elements, comprising a residual or non-residual structure and/or attention modules, as will be described below. At the output of the module MPP′, the image or the plurality of reconstructed images, I(Pdₙ), is/are available.

The decoding device DEC can be implemented by means of an electronic device comprising a processor and a memory, which are not shown; each of the aforementioned modules can thus be produced by way of the interaction of the processor and computer program instructions that are stored in the aforementioned memory and are designed to perform the functionalities of the module in question, in particular as described below, when these instructions are executed by the processor.

FIG. 3 schematically shows synthetic and convolutional artificial neural networks used in one embodiment of the invention during encoding and decoding.

According to this embodiment, the synthesis module contains a neural network MLP/MLP′ and the convolution module contains a neural network MPP/MPP′. The synthetic artificial neural network MLP/MPP used for encoding and the synthetic artificial neural network MLP′/MPP′ used for decoding are defined by an identical structure, for example comprising a plurality of layers of artificial neurons, and by a set of weights and activation functions respectively associated with the artificial neurons of the network in question.

A vector representation of a current sample (a vector Zₙ or Zdₙ obtained from the feature maps FMtᵢ or FMt′ᵢ) is applied to the input (that is to say to an input layer) of the synthetic artificial neural network MLP or MLP′. The synthetic artificial neural network outputs a vector ZLₙ or ZLdₙ of latent values representative of the decoded sample, which are reinserted into the NL latent value maps Lⱼ/L′ⱼ. FIG. 3 shows a layer of the synthetic neural network that contains 40 outputs denoted u₁ . . . u₄₀. Each output is followed by an activation function of the RELU type. The RELU (Rectified Linear Unit) function is well known to those skilled in the art. The output layer contains three components denoted v1 . . . v3, which are likewise followed by a RELU function. At the output of the module MLP/MLP′, the resulting values of each RELU function, containing the vector ZLₙ/ZLdₙ, are introduced into the maps Lj at the position defined by that of the pixel n being processed. The concatenation of all these values forms the decoded latent value maps Lj/L′j. In FIG. 3, the latent value maps are therefore 3 in number.

The decoded latent value maps Lⱼ/L′ⱼ are then processed by the convolution module MPP/MPP′, which outputs a decoded signal, according to one embodiment the color components (R, G, B) that form the image I.

According to the example of FIG. 3, the convolutional network is formed by a residual convolutional layer (CR1) at the input, a set of RELU functions, and a residual convolutional layer (CR2) at the output. The modules CR are residual convolution elements, without any limiting aspect. They can have kernels of any size. They can be simple convolutional types or include attention elements. They can also include strides (offset of the convolution kernel with each iteration), dilation (spacing of the input values supplied to the kernel), etc. A convolution element is potentially followed by a bias, as is well known to those skilled in the art. Any activation function within the ability of a person skilled in the art can be used (ReLU, sigmoid, Softmax, Softplus, Softsign, etc.).

The convolution elements can be composed of 2D convolutions, that is to say the convolution kernel is applied jointly to the rows and columns of the latent value map. The convolution elements can be composed of 1D convolutions, in a separable form. In this case, rather than performing convolution on the two-dimensional latent value map, a first one-dimensional (1D) convolution operator of length Lh is applied to the rows, and then a second convolution of length Lv is performed on the columns of the map obtained after the first operator. The row/column processing can be reversed to perform column and then row processing. This embodiment has the effect of reducing the storage of Lh*Lv for a given kernel that is not separable at Lv+Lh, and limits the complexity to Lh+Lv multiplications per map value as opposed to Lh*Lv in the 2D case

Naturally, the convolution module can itself contain multiple cascaded networks. Each network can contain multiple biased or unbiased convolutional layers accompanied by activation functions of the RELU or another type, etc.

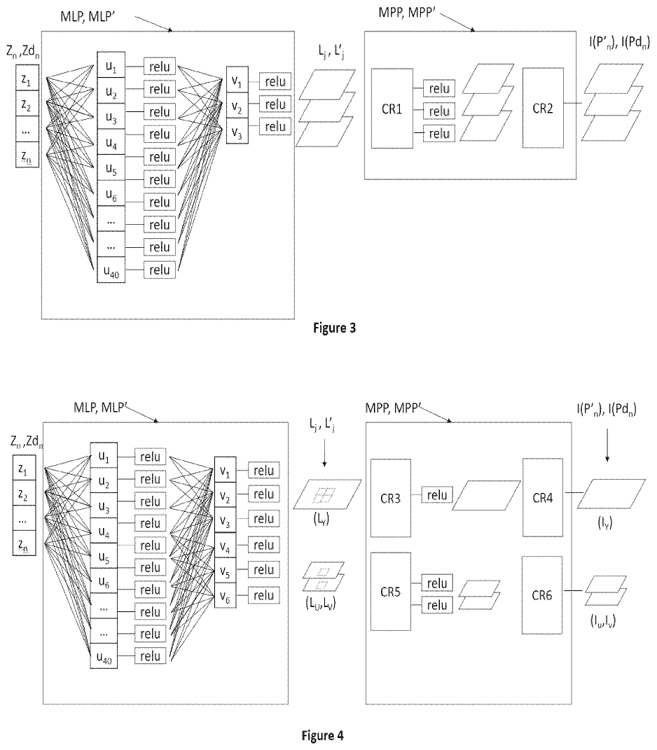

FIG. 4 schematically shows synthetic and convolutional artificial neural networks used in another embodiment of the invention during encoding and decoding.

These networks are able to process images whose components have different resolutions.

As in FIG. 3, according to this embodiment, the synthesis module contains a neural network MLP/MLP′ and the convolution module contains a neural network MPP/MPP′. A vector representation of a current sample (a vector Zₙ or Zdₙ obtained from the feature maps FMtᵢ or FMt′ᵢ) is applied to the input of the synthetic artificial neural network MLP or MLP′. The synthetic neural network outputs a vector ZLₙ or ZLdₙ of latent values representative of the decoded sample, which are reinserted into the NL latent value maps Lj/L′j. FIG. 4 shows a layer of the synthetic neural network that contains 40 neuron outputs denoted u1 . . . u40. Each output is followed by an activation function of the RELU type. The output layer contains six components denoted v1 . . . v6, which are likewise followed by a RELU function. At the output of the module MLP/MLP′, the resulting values of each RELU function are introduced into the maps Lj at the position defined by that of the pixel being processed. The concatenation of all these values forms the decoded latent value maps Lj/L′j. In FIG. 4, the latent value maps are therefore 3 in number.

Unlike FIG. 3, however, in this embodiment, the latent value maps Lⱼ do not all three have the same number of samples. The module MLP/MLP′ generates more latent values for the first map than for those that follow: 4 values are generated for the first map denoted Ly as opposed to 1 for the maps Lᵤ and Lᵥ. This advantageously results in latent value maps corresponding to chroma components, which contain fewer samples than latent value maps corresponding to luminances. Such size adaptation makes it possible to reduce the number of operations performed and the number of network parameters to be encoded and transmitted (or decoded). This number can be adjusted for the dimension of the components.

The decoded latent value maps Lⱼ/L′ⱼ are then processed by the convolution module MPP/MPP′, which outputs a decoded signal, according to this embodiment the color components (I_{Y}, Iᵤ, Iᵥ) that form the image I, the U and V components conventionally containing four times fewer samples than the Y component.

The architecture of the convolutional network is identical to that of FIG. 3, and the same comments apply. The convolution elements are denoted CR1, CR2, CR3 and CR4.

FIG. 5 schematically shows convolutional networks according to embodiments of the invention.

Cases (a) to (d) respectively illustrate convolutional layers used in the context of the invention for processing three latent value maps at the input (NL=3), and a three-component image YUV (NC=3) at the output of the convolution module. In the figure, the oblique lines topped with a digit indicate the number of latent value maps at the input and image components at the output.

Naturally, other embodiments, not shown, can be envisaged, with a more or less high number of latent value maps and a variable number of output components (for example NL=4 latent value maps for an image with NC=3 YUV components at the output), without loss of generality.

Moreover, in the embodiment shown, each latent value map contains only scalar data, in accordance with the definition of a latent value map given previously, and there are three latent value maps, each corresponding to one of the three coordinates of the samples of said signal. However, it is possible to organize the latent values differently, for example by forming a single signal containing, for each sample, a vector having three values, without loss of generality.

These convolutional layers, which use convolution elements denoted Ci, and attention elements (SGM: sigmoid function), can be combined by way of a cascade. The complexity increases with the cases shown, both from the point of view of memory occupancy (number of filter coefficients) and from that of the number of arithmetic operations they involve.

Case (a) shows a simple convolution that processes the NL latent value maps Li/L′i at the input. The NL (according to the example NL=3) maps undergo a simple convolution, denoted C. Filtering is performed using the kernel of the convolution, sized at k×k (for example k=3). The kernel (3×3) is applied to the different positions of the maps to obtain the NC (according to the example NC=3) components of the image (for example YUV) at the output. The number of operations required is therefore 3*3*3*3 (=81). In general, the number of operations is NL*NC*k*k. NL*NC kernels sized at k*k are used and must be stored and/or transmitted. In addition, NC biases must also be stored and/or transmitted.

Case (b) shows the same complexity, but a residual structure: unlike case (a), the signal resulting from the convolution is combined (added, subtracted, multiplied) with the original signal composed of the three intermingled latents. The memory footprint (number of operations) is identical to that of case (a), that is to say NL*NC*k*k operations, but this structure can facilitate learning the neural network.

Case (c) shows a residual structure that processes the NL (according to the example NL=3) latent value maps in a differentiated manner: a map (L′ₒ) is used to generate the Y component, denoted I_{Y}, of the image. Its convolution is denoted C1 and the kernel thereof is sized at k1*k1. The other two maps (L′₁ and L′₂) are used to generate the U and V components of the image, which are denoted I_{U} and I_{V}. Their convolution is denoted C2 and the kernel thereof is sized at k2*k2. The memory footprint is smaller than for the combined processing of the 3 maps, since the number of operations required is 1*1*k1*k1 for C1 and 2*2*k2*k2 for C2. It is necessary to store 3 biases in this case. As explained with reference to FIG. 4, this structure is well suited to processing images having different resolutions.

Case (d) shows a structure containing an attention module SGM that jointly processes the NL latent value maps. The memory footprint is larger since the number of operations required is NL*NC*k3*k3 for C3 and NL*1*k4*k4 for C4. It is necessary to store NC+1 biases in this case. However, this structure improves the local processing of the images, in particular of the contours present in the images.

a. For C2: 2*2*k2*k2

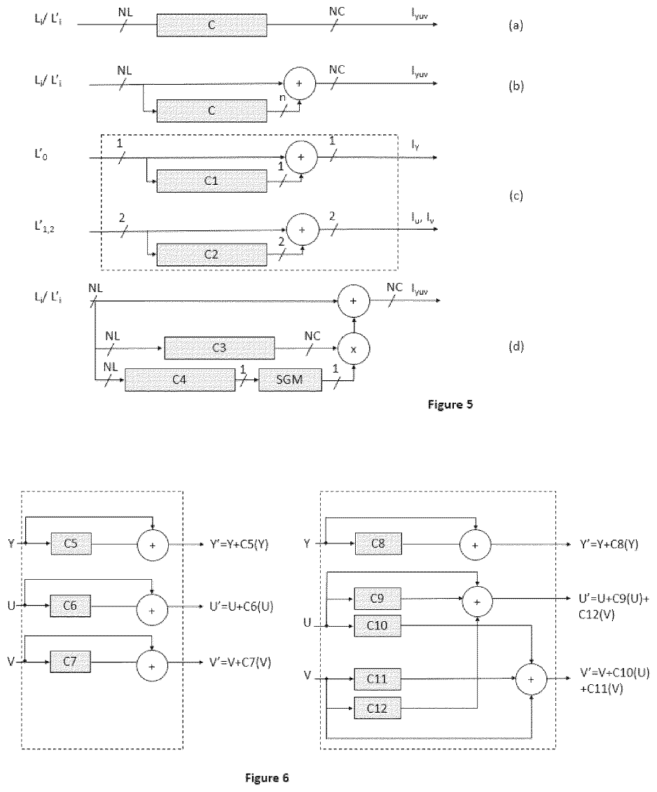

FIG. 6 schematically shows convolutional networks according to embodiments of the invention.

The left-hand part of the figure shows low-complexity differentiated processing that independently processes the three latent value maps. It is able to process maps having different resolutions, so each component of the image can have its own resolution, for example to manage a YUV 420 format for which the U and V components are of reduced size compared to the Y component. The convolution elements are denoted C5, C6 and C7.

The right-hand part of the figure shows an alternative view of the differentiated processing of FIG. 5, case (c). The convolutional network is able to process YUV formats separately; the Y component is processed separately while the U and V components are processed together. The convolution elements are denoted C8, C9, C10, C11 and C12.

The table below summarizes the number of operations required (MAC) and the number of values stored (storage) for each of the cases shown in FIGS. 5 and 6. This example assumes that the latent value maps are three in number (NL=3), that the outputs are three in number (NC=3) and that all the convolution kernels are sized at 3×3 (k=k1=k2= . . . =3).

TABLE 1

| FIG. | MAC | storage |
|---|---|---|
| 5-a | 81 | 84 |
| 5-b | 81 | 84 |
| 5-c | 45 | 48 |
| 5-d | 108 | 112 |
| 6 right | 45 | 48 |
| 6 left | 27 | 30 |

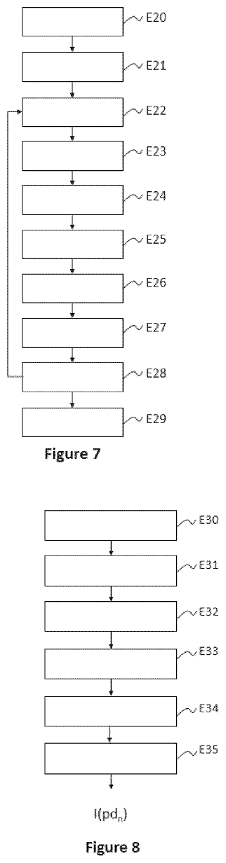

FIG. 7 is a flowchart showing an example of an encoding method that can be carried out by the encoding device of FIG. 1.

According to this embodiment, the signal is a two-dimensional image, and each sample to be encoded is therefore a pixel Pₙ having the coordinates (xₙ, yₙ).

Encoding takes place in two main phases:

In a first phase, referred to as the construction phase, learning is performed in order to determine, for an input signal I(Pₙ), the values of the maps FMᵢ and parameters Wₖ of the synthesis module and Vₖ of the convolutional neural network(s) in order to optimize a cost function. The learning is performed, for example, by way of a gradient descent, followed by an update of the values of the feature maps FMᵢ, and optionally of the synthetic and convolutional neural networks. As is known in the prior art, the cost function can be of the rate/distortion, or rate, or distortion, or perceptual, type. In order to measure the rate R, the encoding of the maps FMᵢ needs to be simulated, then the associated encoding rate (the size of the stream B1) needs to be measured. According to one embodiment, the encoding of the parameters Wₖ and/or Vₖ is not simulated because their influence is less than that of the feature maps. According to one embodiment, the encoding of the parameters Wₖ and/or Vₖ is also simulated and the associated rate (the size of the stream B2) is measured. To measure distortion D, it is necessary to simulate the encoding and then decoding of at least part of the image I, in order to obtain at least one pixel P′ₙ resulting from a simulation of encoding and then decoding, then to measure the difference between this part of the image I(Pₙ) at the input and a corresponding part of the encoded and then decoded image I(P′ₙ).

Next, in a second phase, referred to as the encoding phase, the maps FMᵢ and the parameters Vₖ and perhaps Wₖ are encoded in order to produce the encoded values FMcᵢ and Vcₖ (and perhaps Wcₖ) before transmission or storage. They form the compressed representation of the input signal I(Pₙ).

The steps of a method according to one embodiment of the invention will now be described.

In a step E20, a signal I(Pₙ) to be encoded, containing a plurality of N samples Pₙ, is delivered to the input of the method.

In a step E21, the M feature maps FMᵢ are initialized. Subsequently, the parameters Wₖ of the synthesis module MLP, the values of the maps FMᵢ and the parameters Vₖ of the (at least one) convolutional neural network must be optimized during the construction phase.

According to one embodiment, the maps FMᵢ have the same resolution as the input signal I(Pₙ) and therefore each contain the same number of values N as there are samples Pₙ to be encoded. According to one embodiment, the resolution of the maps FMᵢ is less than or equal to that of the input signal I(Pₙ) and they therefore contain, for at least one of them, a number of values to be encoded that is less than N. According to one variant, the first map FMi has the resolution of the images and each subsequent map has half the resolution of the previous one. According to one embodiment, multiple maps FMi have the same resolution, which is less than that of the input signal I(Pₙ).

According to one embodiment, the maps FMᵢ are initialized with predefined constant values. According to another embodiment, the feature maps are initialized with a set of random real values.

In one embodiment, the structure and parameters of the neural networks are initialized in this step. These parameters are subsequently updated, or refined, during the construction phase, in the later iterations of the method. According to one embodiment, the parameters of the synthesis module and/or of the convolutional neural network are initialized with predefined values that are known to yield a satisfactory cost function value (for example following training on a corpus of images). According to another embodiment, the parameters of the synthesis module and/or of the convolutional neural network are initialized with a set of random values.

The feature maps FMᵢ and the parameters of the neural networks are subsequently updated, or refined, in a step E22, by the updating module MAJ of the encoder during its learning.

In a step E23, the maps FMᵢ are encoded by the module FMC of the encoder. During the construction phase, this operation is an encoding simulation. During the encoding phase, this operation is actual encoding and the encoded values form the stream B1. The simulation can be identical to the actual encoding, but it also can be different (for example simplified). For this encoding, entropy coding of the quantized values of the feature map(s) is used, for example.

In one embodiment, the maps FMᵢ are encoded in the order (FM₁, FM₂, . . . , FM₄), and the variables of each map are encoded in a predefined, for example lexicographic, order. Each map undergoes entropy coding. The entropy coding produces a compressed stream B1, the rate of which is later measured during a step E28.

In a step E24, according to one embodiment, the M maps FMᵢ are quantized, transformed, and data are extracted therefrom by the module XTR.

According to one embodiment, the resolution of at least one map FMᵢ is less than that of the images of the sequence to be encoded and the transformation operation comprises up-sampling, so that the transformed map FMtᵢ contains the same number of samples as the images of the sequence. Up-sampling involves adding values to the maps FMtᵢ in order to arrive at the resolution of the images of the input sequence. It can be simple (by replicating the nearest neighbor) or include an interpolation (linear, polynomial, filtering, etc.). It can be performed by an up-sampling neural network.

According to one embodiment, the module XTR extracts values from the transformed feature maps FMtᵢ, for a sample Pₙ to be encoded, according to its coordinates in the input signal. The extracted values form the vector Zₙ. Zₙ is a J-tuple, that is to say it contains J elements, or data zᵢ. The vector Zₙ of index n refers to the characteristic vector of the pixel P′ₙ.

In one embodiment, Zₙ is a J-tuple (z₁, z₂, . . . , z_{J}) formed by the values from the maps FMᵢ located at the coordinates (xₙ, yₙ) of the current pixel Pₙ. In one embodiment, Zₙ is a J-tuple constructed from values taken from the maps FMi at coordinates that can differ depending on the maps. For example, if the maps FMᵢ have different resolutions because they have been down-sampled, the coordinates are adapted (by scaling) to match the resolution of each map. In one embodiment, Zₙ is a J-tuple constructed from values taken from the maps FMᵢ by applying the processing to one or more values of the maps, for example filtering the neighboring values of the targeted value in a map. For example, for a current sample Pₙ in a map FMᵢ that has the same resolution as the input signal, it is possible to extract the values located at the coordinates (xₙ, yₙ), (xₙ−1, yₙ), (xₙ, yₙ−1) and (xₙ−1, yₙ−1) and to apply processing to these values (filtering, averaging, interpolation, etc.) in order to obtain the final value (zᵢ) of the element i of the vector Zₙ relating to this map FMᵢ. According to another example, in a map FMᵢ that has half the resolution of the input signal, the values located at the coordinates (xₙ/2, yₙ/2), (xₙ/2−1, yₙ/2), (xₙ/2, yₙ/2−1) and (xₙ/2−1, yₙ/2−1) can be considered and these values can have processing applied to them (filtering, averaging, interpolation, etc.) in order to obtain the final value (zᵢ) of the element i of the vector Zₙ relating to this map FMᵢ. The samples to be encoded are, for example, processed in sequential order, from n=1 to n=N.

In a step E25, the feature maps are processed by the synthesis module to generate latent value maps. The synthesis module is, for example, a neural network, or a filter bank, or a linear inverse transformation (wavelet, DCT, etc.), defined by its parameters Wₖ that is able to process the transformed feature maps at the input to output a set of NL latent maps Lⱼ with 1<j<=NL.

According to one embodiment, the vector Zₙ is processed by a synthetic neural network MLP to output a second vector ZLₙ containing NL latent values for the sample Pₙ to be encoded. According to one embodiment, NL is equal to 3 and the output vector is a triplet to be inserted into three maps L₁, L₂ and L₃. According to another embodiment, NL is equal to 4 and the output vector is a quadruplet to be inserted into four latent value maps L₁-L₄ at the coordinates of the pixel. According to another embodiment, NL lies between the number M of maps FMᵢ and the number of components of the image, M≤NL≤3 for NC=3 components. It is also possible to organize the latent values differently, for example by forming a single signal containing, for each sample, a vector of NL scalar values, without loss of generality. The latent value maps represent an intermediate signal before convolutional processing.

In a step E26, the (at least one) convolutional neural network MPP is applied at the output of the module MLP to the latent value maps (Lⱼ) to obtain decoded samples P′ₙ, for example vectors representative of the samples Pₙ to be encoded, according to one embodiment the triplet (R, G, B) of the sample P′ₙ (the encoded and then decoded sample Pₙ).

In a step E27, the parameters Vₖ and Wₖ of the synthesis and convolution modules are quantized and encoded. During the construction phase, this operation is an encoding simulation. During the encoding phase, this operation is actual encoding and the encoded values form the stream B2. The simulation can be identical to the actual encoding, but it also can be different (for example simplified). To this end, any known technique can be used, for example the neural network encoding standard proposed in part 17 of the MPEG-7 standard, also called NNR (Neural Network Representation). It should be noted that in this case the amount of degradation that the encoding causes for the parameters Vₖ and Wₖ needs to be selected.

In a step E28, a performance measurement is evaluated.

To this end, the encoding simulation rates associated with the feature maps (simulation of the stream B1 by encoding the maps FMᵢ) and optionally with the parameters of the synthesis and convolution modules (simulation of the stream B2 by encoding the parameters Vₖ/Wₖ) are measured.

According to one embodiment, the cost function is of the rate/distortion type, denoted (D+L*R), where D is, for example, the squared error measured between the input signal and the decoded signal (or the error measured on a subset of samples of the signal). According to another example, D is computed from a perceptual function such as SSIM (Structural SIMilarity), or MSSSIM (Multi-scale Structural SIMilarity). According to one embodiment, R is the simulated rate of the stream B1; according to another embodiment, R is the total rate used to encode this image or sequence of images, that is to say the sum of the simulated rates of B1 and B2. L is a parameter that adjusts the rate/distortion compromise. Other cost functions are possible.

Until the cost function reaches its minimum, the performance measurement remains unsatisfactory, and the method is repeated from step E22. This minimization can be performed by a mechanism known as a gradient descent with updating of the parameters during step E22. If the cost function has reached its minimum, training stops. If an encoded version corresponding to the last simulation of the parameters of the synthesis and convolution modules (Vₖ/Wₖ) and of the feature maps (FMᵢ) is available, the streams B1 and B2 can be formed thereby. According to another embodiment, the actual encoding of the updated parameters of the synthesis and convolution modules (Vₖ/Wₖ) and of the values of the feature maps (FMᵢ) is performed in this step to produce the encoded parameters Vcₖ/Wcₖ and FMcᵢ forming streams B2 and B1. The streams B1 and B2 can be concatenated in order to produce a final stream. According to one embodiment, the stream B2 of the encoded parameters of the synthesis and convolution modules is stored or transmitted before the stream B1 in order to be able to be decoded before the stream B1.

FIG. 8 is a flowchart showing an example of a decoding method that can be carried out by the decoding device of FIG. 2.

In a step E30, the streams B1 and B2 are extracted from the encoded stream. They respectively contain the encoded representations of the maps FMcᵢ and parameters of the synthesis and convolution modules Wcₖ and Vcₖ.

In a step E31, the M maps FMdᵢ are generated by decoding the values FMcᵢ. For this decoding, a decoding technique corresponding to that used by the encoder is used, for example entropy (de)coding. In one embodiment, the maps FMdᵢ are decoded in the order (FMdᵢ, FMd₂, . . . , FMd₄), and the values of each map are decoded in a predefined, for example lexicographic, order. The parameters Wdₖ and Vdₖ of the synthesis and convolution modules are generated by decoding the values Wcₖ and Vcₖ of the stream B2. To this end, any known decoding technique corresponding to the encoding technique used by the encoder can be used. The (at least one) convolutional neural network MPP′ is similar to the synthetic network MPP, that is to say it has the same structure and contains the same parameters, except for the encoding, which can be carried out lossily or losslessly. The same applies to the synthesis module, which can be implemented in the form of a neural network.

According to one embodiment, the stream B2 is decoded before the stream B1 in order to obtain the parameters of the synthesis and convolution modules before starting to decode the samples.

According to embodiments as described for the encoder: the maps FMdᵢ have the same resolution as the signal to be recovered I (Pdₙ) and therefore each contain the same number of values N as there are samples Pdₙ to be decoded; the resolution of the maps FMdᵢ is less than or equal to that of the signal and they therefore contain, for at least one of them, a number of values to be decoded that is less than N. According to one variant, the first map FMdi has the resolution of the images and each subsequent map has half the resolution of the previous one. According to one embodiment, multiple maps FMdi have the same resolution, which is less than that of the signal.

In a step E33, according to embodiments, the M maps FMdᵢ are dequantized, transformed, and data are extracted therefrom by the module XTR′.

According to one embodiment, the resolution of at least one map FMdᵢ is less than that of the images to be decoded and the transformation operation comprises up-sampling, so that the transformed map FMt′ᵢ contains the same number of samples as the images of the sequence. Up-sampling involves adding values to the maps FMt′ᵢ in order to arrive at the resolution of the images of the input sequence. It can be simple (by replicating the nearest neighbor) or include an interpolation (linear, polynomial, filtering, etc.). It can be performed by an up-sampling neural network.

According to one embodiment, the module XTR′ extracts values from the transformed feature maps FMt′ᵢ, for a sample Pdₙ to be decoded, according to its coordinates in the signal. The extracted values form the vector Zdₙ. Zdₙ is a J-tuple, that is to say it contains J elements, or data zdᵢ. The vector Zdₙ of index n refers to the characteristic vector of the pixel Pdₙ.

This step is similar to step E24 described for the encoder with reference to FIG. 7, and the embodiments are applicable. In particular: In one embodiment, Zdₙ is a J-tuple (zd₁, zd₂, . . . , zd_{J}) formed by the values from the maps FMt′ᵢ/FMdᵢ located at the coordinates (xₙ, yₙ) of the current pixel Pdₙ. In one embodiment, Zₙ is a J-tuple constructed from values taken from the maps FMt′ᵢ/FMdᵢ at coordinates that can differ depending on the maps. For example, if the maps FMt′ᵢ/FMdᵢ have different resolutions because they have been down-sampled, the coordinates are adapted (by scaling) to match the resolution of each map. In one embodiment, Zdₙ is a J-tuple constructed from values taken from the maps FMt′ᵢ/FMdᵢ by applying the processing to one or more values of the maps, for example filtering the neighboring values of the targeted value in a map. For example, for a current sample Pdₙ in a map FMdᵢ that has the same resolution as the image signal to be decoded, it is possible to extract the values located at the coordinates (xₙ, yₙ), (xₙ−1, yₙ), (xₙ, yₙ−1) and (xₙ−1, yₙ−1) and to apply processing to these values (filtering, averaging, interpolation, etc.) in order to obtain the final value (zdᵢ) of the element i of the vector Zₙ relating to this map FMt′ᵢ/FMdᵢ. In another example, in a map FMt′ᵢ/FMdᵢ that has half the resolution of the signal, the values located at the coordinates (xₙ/2, yₙ/2), (xₙ/2−1, yₙ/2), (xₙ/2, yₙ/2−1) and (xₙ/2−1, yₙ/2−1) can be considered and these values can have processing applied to them (filtering, averaging, interpolation, etc.) in order to obtain the final value (zdᵢ) of the element i of the vector Zdₙ relating to this map FMᵢ. The samples to be decoded are processed, for example, in sequential order, from n=1 to n=N.

In a step E34, the feature maps are processed by the synthesis module MLP′ to generate latent value maps. The synthesis module is, for example, a neural network, or a filter bank, or a linear inverse transformation (wavelet, DCT, etc.), defined by its parameters Wdₖ that is able to process the transformed feature maps at the input to output a set of NL latent maps L′ⱼ with 1<j<=NL.

This step is similar to step E25 described for the encoder with reference to FIG. 7, and the embodiments are applicable. In particular, according to one embodiment, the vector Zdₙ is processed by a synthetic neural network MLP′ to output a second vector ZLdₙ containing NL latent values for the sample Pdₙ to be decoded. According to one embodiment, NL is equal to 3 and the output vector is a triplet to be inserted into three maps L′₁, L′₂ and L′₃. According to another embodiment, NL is equal to 4 and the output vector is a quadruplet to be inserted into four latent value maps L′₁-L′₄ at the coordinates of the pixel. According to another embodiment, NL lies between the number M of maps FMdᵢ and the number of components of the image, M≤NL≤3 for NC=3 components. It is also possible to organize the latent values differently, for example by forming a single signal containing, for each sample, a vector of NL scalar values, without loss of generality. The latent value maps represent an intermediate signal before convolutional processing.

In a step E35, the (at least one) convolutional neural network MPP′ is applied at the output of the module MLP′ to the latent value maps (L′ⱼ) to obtain decoded samples Pdₙ, for example vectors representative of the samples Pdₙ to be decoded, according to one embodiment the triplet (R, G, B) of the sample Pdₙ. This step is similar to step E26 described for the encoder with reference to FIG. 7.

When all the latent value maps have been processed, the decoded signal corresponding, for example, to the image I(Pdₙ) is available.

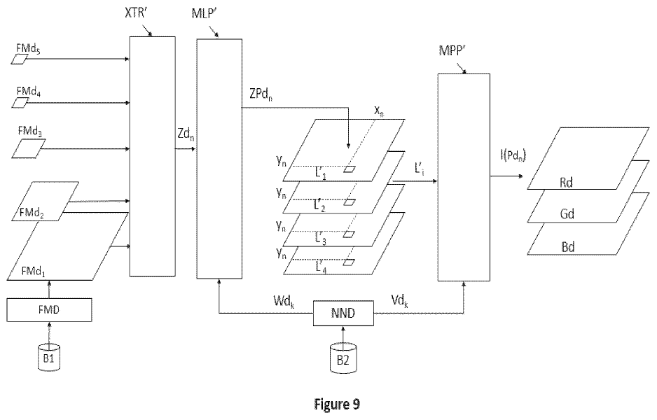

FIG. 9 shows an illustration of a decoding method used in one embodiment of the invention.

In this embodiment, the maps FMdᵢ are 5 in number. In one preferred embodiment, they are 7 in number.

In this embodiment, the first map FMdᵢ has the same resolution as the image I, and therefore contains W×H variables, where W is the width of the image in pixels, and H its height. The second map FMd₂ has half the resolution (in each dimension) of the map FMd₁. The map FMd₃ has half the resolution (in each dimension) of the map FMd₂. The maps FMd₄ and FMd₅ have half the resolution (in each dimension) of the map FMd₃. This structure allows the number of variables in the feature maps to be reduced, thus facilitating decoding, while minimizing the cost of encoding.

The module XTR′ dequantizes, if necessary, the values of the feature maps.

The feature maps are then processed by the module XTR′, which, according to this embodiment, up-samples them in order to give them the same resolution as the image to be decoded. (FMd₂ is up-sampled by a factor of 2 in each dimension, FMd₃ is up-sampled by a factor of 4 in each dimension, etc.)

The module XTR′ then extracts, for each sample position, a vector Zdₙ in the form of a 5-tuple (zd₁ . . . zd₅) formed by the values of the transformed maps FMdᵢ located at the coordinates (xₙ, yₙ) of the current pixel Pdₙ. The vector Zdₙ is processed by the neural network MLP′ to output a vector ZPdₙ, according to the example a quadruplet that is representative of the sample Pdₙ to be decoded, which is reintroduced into the latent value maps L′ᵢ at the coordinates (xₙ, yₙ) in the components.

According to this example, the latent value maps L′ᵢ are 4 in number.

The 4 latent value maps are processed by the convolution module MPP′ to output, according to this example, the 3 components Rd, Gd and Bd of the decoded image.

1-20. (canceled)

21. An encoding method for encoding at least one image, the method being implemented by an encoding device and comprising:
constructing said at least one image, comprising:
constructing a group of feature maps;
obtaining a group of latent value maps by processing said group of feature maps by way of a synthesis module, the number of the latent value maps being less than or equal to the number of the feature maps;
obtaining said at least one image by processing said group of latent value maps by way of at least one convolutional neural network; and
updating at least one value of one of said feature maps according to an encoding performance measurement; and
encoding said group of feature maps.

22. The encoding method as claimed in claim 21, wherein said at least one image comprises a plurality of samples to be encoded, and the processing of said group of feature maps comprises:
for at least one current sample of said image, which sample is associated with a position:
constructing a characteristic vector from said feature maps according to said position of said current sample;
processing said characteristic vector by way of said synthesis module to provide a latent vector that is representative of a latent value of the current sample; and
constructing the group of latent value maps from said at least one latent vector.

23. The encoding method as claimed in claim 21, wherein said synthesis module comprises a multilayer perceptron.

24. The encoding method as claimed in claim 21, wherein said at least one convolutional neural network contains at least one convolutional layer.

25. The encoding method as claimed in claim 21, wherein the number of latent value maps is equal to a number of components of said at least one image.

26. A decoding method for decoding at least one image from a bit stream, the method being implemented by a decoding device and comprising:
obtaining, by decoding, a group of feature maps;
obtaining a group of latent value maps by processing said group of feature maps by way of a synthesis module, the number of the latent value maps being less than or equal to the number of the feature maps; and
obtaining said at least one decoded image by processing said group of latent value maps by way of at least one convolutional neural network.

27. The decoding method as claimed in claim 26, further comprising obtaining a set of synthesis parameters representative of said synthesis module.

28. The decoding method as claimed in claim 26, further comprising obtaining a set of convolution parameters representative of said at least one convolutional neural network.

29. The decoding method as claimed in claim 26, wherein said at least one image comprises a plurality of samples to be decoded, and the processing of said group of feature maps comprises:
for at least one current sample of said at least one image to be decoded, which sample is associated with a position:
constructing a characteristic vector from the feature maps according to said position of said current sample;
processing said characteristic vector by way of said synthesis module to provide a latent vector that is representative of a latent value of the current sample; and
constructing the group of latent value maps from said at least one latent vector.

30. The decoding method as claimed in claim 26, wherein said synthesis module comprises a multilayer perceptron.

31. The decoding method as claimed in claim 26, wherein said at least one convolutional neural network contains at least one convolutional layer.

32. The decoding method as claimed in claim 26, wherein the number of latent value maps is equal to a number of components of said at least one image.

33. The decoding method as claimed in claim 26, wherein at least part of a set of synthesis and/or convolution parameters for the synthesis module and/or the at least one convolutional neural network is obtained from data of said bit stream.

34. The decoding method as claimed in claim 26, wherein at least part of a set of synthesis and/or convolution parameters for the synthesis module and/or the at least one convolutional neural network is obtained from predetermined parameters.

35. The decoding method as claimed in claim 26, wherein at least part of a set of synthesis and/or convolution parameters for the synthesis module and/or the at least one convolutional neural network is decoded according to reference parameters.

36. The decoding method as claimed in claim 26, wherein said at least one convolutional neural network contains at least two convolutional neural networks.

37. The decoding method as claimed in claim 36, wherein the bit stream contains an indicator indicating use of at least one of said neural networks.

38. The decoding method as claimed in claim 31, wherein said at least one image has at least two dimensions, and said convolutional layer uses a kernel that is separable in said at least two dimensions.

39. A device for encoding at least one image, wherein the device comprises:
at least one processor; and
at least one non-transitory computer readable medium comprising instructions stored thereon which when executed by the at least one processor configure the encoding device to carry out:
constructing said at least one image, comprising:
constructing a group of feature maps;
obtaining a group of latent value maps by processing said group of feature maps by way of a synthesis module, the number of the latent value maps being less than or equal to the number of the feature maps;
obtaining said at least one image by processing said group of latent value maps by way of at least one convolutional neural network; and
updating at least one value of one of said feature maps according to an encoding performance measurement; and
encoding said group of feature maps.

40. A device for decoding at least one image from a bit stream, wherein said device comprises:
at least one processor; and
at least one non-transitory computer readable medium comprising instructions stored thereon which when executed by the at least one processor configure the decoding device to carry out:
obtaining, by decoding, a group of feature maps;
obtaining a group of latent value maps by processing said group of feature maps by way of a synthesis module, the number of the latent value maps being less than or equal to the number of the feature maps; and
obtaining said at least one decoded image by processing said group of latent value maps by way of at least one convolutional neural network.

41. A non-transitory computer readable medium comprising a computer program stored thereon containing instructions for performing an encoding method as claimed in claim 21 when said program is executed by at least one processor of the encoding device.

42. A non-transitory computer readable medium comprising a computer program stored thereon containing instructions for performing a decoding method as claimed in claim 26 when said program is executed by at least one processor of the decoding device.
